(19) United States
(12) Patent Application Publication
(10) Pub. No.: US 2025/0042704 A1
(43) Pub. Date: Feb. 6, 2025

(54) INDEPENDENT ELECTRONIC STEERING AXLE AND FOUR-FULCRUM COUNTERBALANCE FORKLIFT

(71) Applicant: BANYITONG SCIENCE AND TECHNOLOGY DEVELOPING CO., LTD., Hefei (CN)

(72) Inventors: Zijian FANG, Hefei (CN); Long HAN, Hefei (CN); Tunli WANG, Hefei (CN)

(73) Assignee: BANYITONG SCIENCE AND TECHNOLOGY DEVELOPING CO., LTD., Hefei (CN)

(21) Appl. No.: 18/719,832

(22) PCT Filed: Apr. 14, 2022
(86) PCT No.: PCT/CN2022/086824

§ 371 Date: Jun. 14, 2024

(30) Foreign Application Priority Data
Dec. 14, 2021 (CN) 202111532215.4

(51) Int. Cl. B66F 9/075

(52) U.S. Cl. CPC B66F 9/07568; B66F 9/07554

(57) ABSTRACT

An independent electronic steering axle includes: a swing axle, where the swing axle is rotatably connected to a vehicle body; wheel frames, where the wheel frames are respectively arranged at two ends of the swing axle, an upper part of the wheel frame is rotatably connected to an end of the swing axle through a rotary support member, and a lower part of the wheel frame is mounted with a steering wheel; steering motors, where the steering motors are respectively arranged at the two ends of the swing axle; and feedback assemblies, where the feedback assemblies are respectively arranged at the two ends of the swing axle. The independent electronic steering axle is applied on the four-fulcrum counterbalance forklift, which realizes a steering function of the forklift, provides an accurate steering control progress, greatly improves a steering response speed, and reduces an energy consumption of the forklift and noise.

### CROSS REFERENCE TO THE RELATED APPLICATIONS

This application is the national phase entry of International Application No. PCT/CN2022/086824, filed on Apr. 14, 2022, which is based upon and claims priority to Chinese Patent Application No. 202111532215.4, filed on Dec. 14, 2021, the entire contents of which are incorporated herein by reference.

### TECHNICAL FIELD

The present invention relates to the technical field of forklift steering axle equipment, and more particularly, to an independent electronic steering axle and a four-fulcrum counterbalance forklift.

### BACKGROUND

At present, mainstream four-fulcrum counterbalance forklifts all adopt a hydraulic steering mode, that is, the hydraulic steering cylinder is fixed on the steering axle, then the steering linkage mechanism is connected in series with the steering wheels located on both sides of the steering axle, and the hydraulic transmission drives the two steering wheels to turn synchronously, so as to realize the forklift steering. The above steering device has obvious deficiencies in use:

(1) After the forklift is transformed into automatic guided vehicle (AGV) unmanned forklift, the steering position cannot be accurately controlled, the response speed is slow, the energy consumption is high, and the noise is high, so the vehicle cannot meet the needs of the future development of AGV unmanned forklift.

(2) Due to the limitation of hydraulic cylinder and steering linkage, at present, the steering axle of the mainstream four-fulcrum counterbalance forklift cannot turn around the center point of the front track, so the turning radius is large, and the flexibility of the forklift is poor.

### SUMMARY

An objective of the present invention is to provide an independent electronic steering axle and a four-fulcrum counterbalance forklift to solve the problems raised in the background technology.

In order to achieve the above objective, the present invention provides the following technical solution:

An independent electronic steering axle includes:
a swing axle, where the swing axle is rotatably connected to a vehicle body;
wheel frames, where the wheel frames are respectively arranged at two ends of the swing axle, an upper part of the wheel frame is rotatably connected to an end of the swing axle through a rotary support member, a lower part of the wheel frame is mounted with a steering wheel, and a rotary rack wheel is mounted on the wheel frame;
steering motors, where the steering motors are respectively arranged at the two ends of the swing axle, a power output shaft of the steering motor is provided with a steering gear engaged with the rotary rack wheel; the steering motor is electrically connected to a motor controller, and the motor controller is electrically connected to a main controller; and
feedback assemblies, where the feedback assemblies are respectively arranged at the two ends of the swing axle, and the feedback assembly is drivingly connected to the corresponding rotary rack wheel and electrically connected to the main controller.

Preferably, the swing axle is rotatably connected to the vehicle body through a connecting shaft and a connecting base on a symmetrical axis.

Preferably, the power output shaft of the steering motor is drivingly connected to a reducer, the steering gear engaged with the rotary rack wheel is mounted on an output shaft of the reducer, and a motor encoder electrically connected to the motor controller is built in the steering motor.

Preferably, the rotary rack wheel and the steering gear are configured in gear structures engaged with each other.

Preferably, the rotary rack wheel and the steering gear are configured in sprocket structures and drivingly connected by a chain.

Preferably, the feedback assemblies include encoders arranged at the two ends of the swing axle and electrically connected to the main controller, where an input shaft of the encoder is provided with a feedback gear engaged with the rotary rack wheel.

Preferably, the feedback assemblies include potentiometers arranged at the two ends of the swing axle and electrically connected to the main controller, where an input shaft of the potentiometer is provided with a feedback gear engaged with the rotary rack wheel.

The present invention further provides a four-fulcrum counterbalance forklift, including the aforementioned independent electronic steering axle.

Compared with the prior art, the advantages of the present invention are as follows:

In the present invention, the independent electronic steering axle instead of a traditional hydraulic steering axle is arranged and applied on the four-fulcrum counterbalance forklift, which realizes a steering function of the forklift, provides an accurate steering control progress, greatly improves a steering response speed, and reduces an energy consumption of the forklift and noise. Moreover, the two steering wheels can turn 360° without mechanism interference, which makes the forklift have a minimum turning radius mode, greatly reduces a turning radius of the forklift, and improves a flexibility of the forklift. In addition, the electronic control system provides a better control environment for controlling the four-fulcrum counterbalance forklift AGV, which greatly improves an upper limit of the driving speed and control accuracy of the four-fulcrum counterbalance forklift AGV.

### BRIEF DESCRIPTION OF THE DRAWINGS

FIG. 1 is a schematic diagram of the structure of the present invention.

FIG. 2 is an enlarged view of the structure of the area A circled in FIG. 1.

FIG. 3 is a cross-sectional view of an A-A direction in FIG. 1.

In the figures: 1. swing axle, 2. connecting shaft, 3. connecting base, 4. wheel frame, 5. rotary support member, 6. rotary rack wheel, 7. steering wheel, 8. steering motor, 9. steering gear, 10. reducer, 11. motor controller, 12. main controller, 13. encoder, and 14. feedback gear.

### DETAILED DESCRIPTION OF THE EMBODIMENTS

The technical solution in the embodiments of the present invention will be described clearly and completely below in conjunction with the drawings in the embodiments of the present invention. It is obvious that the described embodiments are only part of the embodiments of the present invention, not all embodiments. Based on the embodiments of the present invention, all other embodiments obtained by those skilled in the art without creative work shall fall within the scope of protection of the present invention.

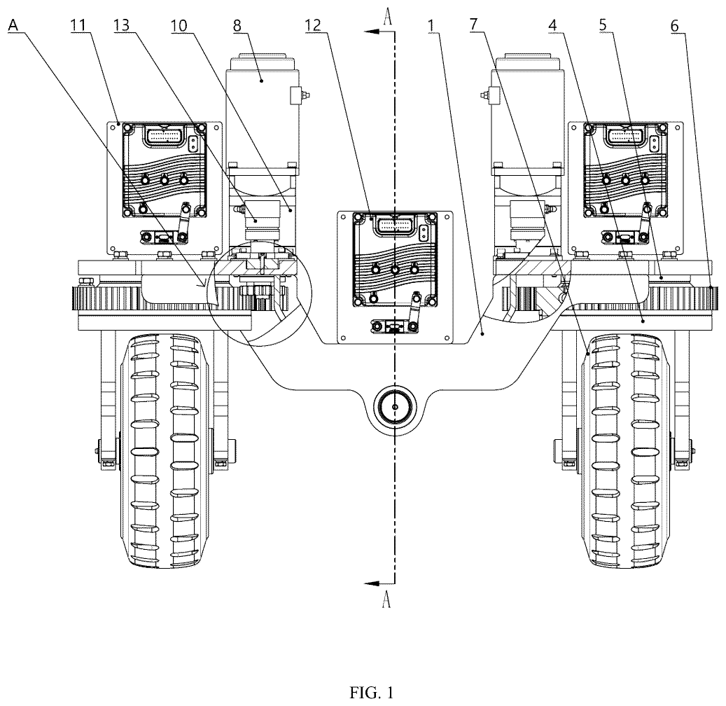

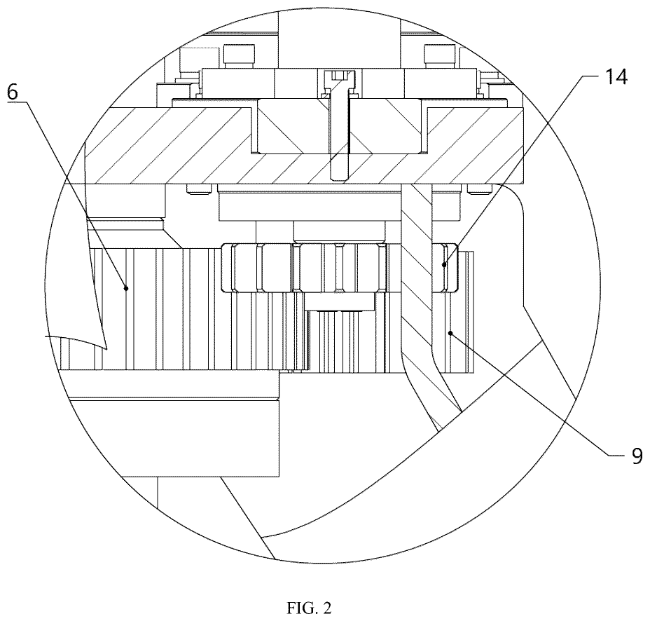

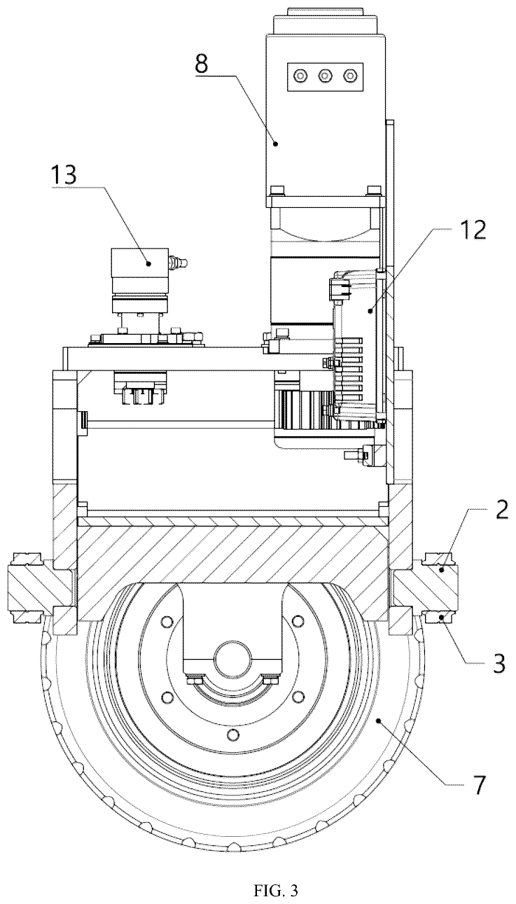

Referring to FIGS. 1-3, the present invention provides a technical solution:

An independent electronic steering axle includes the swing axle 1, wheel frames 4, steering motors 8, and feedback assemblies.

The swing axle 1 is rotatably connected to the rear part of a vehicle body through the connecting shaft 2 and the connecting base 3 on a symmetrical axis, and two ends of the swing axle 1 can swing up and down by taking the connecting shaft 2 as the circular center, thereby ensuring that a four-fulcrum counterbalance forklift can still effectively contact the ground when driving on an uneven road to provide effective support and adhesion.

Two wheel frames 4 are respectively arranged at the two ends of the swing axle 1. The upper part of the wheel frame 4 is rotatably connected to an end of the swing axle 1 through the rotary support member 5, and the lower part of the wheel frame 4 is mounted with the steering wheel 7. The rotary rack wheel 6 is mounted on the wheel frame 4. Under the action of a control device and a power device, the steering wheels 7 on both sides can rotate independently around a rotary point by 360°, so that the vehicle has good flexibility and controllability.

Two steering motors 8 are respectively fixed at the two ends of the swing axle 1, and a power output shaft of the steering motor 8 is drivingly connected to the reducer 10. The reducer 10 is fixed on the swing axle 1, and the steering motor 8 and the reducer 10 provide power output for the steering. The steering gear 9 engaged with the rotary rack wheel 6 is mounted on an output shaft of the reducer 10, so that the power outputted by the steering motor 8 is transmitted to the wheel frame 4 after deceleration and torque-increasement through the reducer 10, and indirectly drives the feedback gear 14 to rotate at the same time. The rotary rack wheel 6 and the steering gear 9 are configured in gear structures engaged with each other. As a preferred technical solution of the present embodiment, the rotary rack wheel 6 and the steering gear 9 may also be configured in sprocket structures and drivingly connected by a chain, and the steering motors 8 drive the steering wheels 7 on both sides through the sprocket and the chain to rotate independently. The motor is arranged to drive the steering wheel 7 to rotate independently, which can save at least 50% energy consumption in comparison with the steering axle of the traditional hydraulic-driven forklift, increase the working endurance of the forklift with the same battery capacity, and reduce the use cost and steering noise of the forklift. Due to the absence of hydraulic leakage, it effectively avoids the working environment pollution of the follow-up four-fulcrum counterbalance forklift.

The steering motors 8 are electrically connected to the motor controllers 11, and the motor controllers 11 are respectively arranged at the two ends of the swing axle 1. The motor controllers 11 are electrically connected to the main controller 12, and the motor controllers 11 are configured to control the rotating speed, start and stop of the steering motors 8. The main controller 12 is arranged on the swing axle 1, and the main controller 12 is configured to issue commands to the motor controllers 11 and receive and determine position signals of the two steering wheels 7 of a feedback assembly.

The steering wheels 7 on both sides do not mechanically interfere with each other, and the two steering wheels 7 can turn 360°, so that the four-fulcrum counterbalance forklift can not only have the minimum turning radius under a normal driving mode, but also have a minimum turning radius steering mode. In the minimum turning radius steering mode, the two steering wheels 7 turn to a splayed angle state, and the angle is determined by the wheelbase of the forklift. The main controller 12 send commands to the motor controllers 11, respectively, and inputs the commands to the steering motors 8 for execution, and the position accuracy is monitored by the feedback assembly. When the forklift is in the minimum turning radius mode, the forklift can rotate around the center point of the front track, which greatly reduces the turning radius and improves the flexibility of the forklift.

The feedback assemblies are respectively arranged at the two ends of the swing axle 1, and the feedback assembly is drivingly connected to the corresponding rotary rack wheel 6 and electrically connected to the main controller 12. The feedback assemblies include the encoders 13 arranged at the two ends of the swing axle 1 and electrically connected to the main controller 12. An input shaft of the encoder 13 is connected to the feedback gear 14 through an encoder base, and the feedback gear 14 is engaged with the rotary rack wheel 6. When the rotary rack wheel 6 drives the feedback gear 14 to rotate, the input shaft of the encoder 13 rotates immediately, so that a steering angle position signal corresponding to the position of the wheel frame 4 is generated and outputted to the main controller 12 for determination and identification. As a preferred technical solution of the present embodiment, the encoder 13 may also be a potentiometer with the same function.

In the present embodiment, in order to more accurately control the steering angle position accuracy of the two steering wheels 7, not only the position feedback assembly includes the encoder 13, but also a motor encoder electrically connected to the motor controller 11 is built in the steering motor 8 to further monitor the steering angle position of the steering wheel assembly. Therefore, the present invention has an electrical double redundancy security assurance design to achieve more accurate and safer steering position accuracy, which provides better control accuracy and control environment for the control and safety of the follow-up four-fulcrum counterbalance forklift AGV and reduces the difficulty of control design and the risk of out of control of the forklift.

The present invention further provides a four-fulcrum counterbalance forklift, including the aforementioned independent electronic steering axle.

Working principle: the main controller 12 sends control signals to the motor controllers 11, and the motor controllers 11 output the steeling angle and rotating speed signals to the two steering motors 8 to respectively drive the two steering wheels 7 to steer according to the requirements, and the two feedback assemblies feed back the real-time position signals of the two steering wheels 7 to the main controller 12, respectively, thus accomplishing the steering requirements of different modes, angles, and rotating speeds of the forklift.

Although embodiments of the present invention have been shown and described, for those skilled in the art, it is understandable that a variety of changes, alterations, replacements and modifications may be made to these embodiments without departing from the principle and spirit of the present invention, and the scope of the present invention is limited by the attached claims and their equivalents.

What is claimed is:

1. An independent electronic steering axle, comprising:
a swing axle, wherein the swing axle is rotatably connected to a vehicle body;
wheel frames, wherein the wheel frames are respectively arranged at two ends of the swing axle, upper parts of the wheel frames are respectively rotatably connected to the two ends of the swing axle through rotary support members, a lower part of each of the wheel frames is mounted with a steering wheel, and a rotary rack wheel is mounted on each of the wheel frames;
steering motors, wherein the steering motors are respectively arranged at the two ends of the swing axle, a power output shaft of each of the steering motors is provided with a steering gear engaged with the rotary rack wheel; each of the steering motors is electrically connected to a motor controller, and the motor controller is electrically connected to a main controller; and
feedback assemblies, wherein the feedback assemblies are respectively arranged at the two ends of the swing axle, and each of the feedback assemblies is drivingly connected to the rotary rack wheel and electrically connected to the main controller.

2. The independent electronic steering axle according to claim 1, wherein the swing axle is rotatably connected to the vehicle body through a connecting shaft and a connecting base on a symmetrical axis.

3. The independent electronic steering axle according to claim 2, wherein the power output shaft of each of the steering motors is drivingly connected to a reducer, the steering gear engaged with the rotary rack wheel is mounted on an output shaft of the reducer, and a motor encoder electrically connected to the motor controller is built in each of the steering motors.

4. The independent electronic steering axle according to claim 3, wherein the rotary rack wheel and the steering gear are configured in gear structures engaged with each other.

5. The independent electronic steering axle according to claim 3, wherein the rotary rack wheel and the steering gear are configured in sprocket structures and drivingly connected by a chain.

6. The independent electronic steering axle according to claim 1, wherein the feedback assemblies comprise encoders, wherein the encoders are respectively arranged at the two ends of the swing axle and electrically connected to the main controller, wherein and an input shaft of each of the encoders is provided with a feedback gear engaged with the rotary rack wheel.

7. The independent electronic steering axle according to claim 1, wherein the feedback assemblies comprise potentiometers, wherein the potentiometers are respectively arranged at the two ends of the swing axle and electrically connected to the main controller, and an input shaft of each of the potentiometers is provided with a feedback gear engaged with the rotary rack wheel.

8. A four-fulcrum counterbalance forklift, comprising the independent electronic steering axle according to claim 1.

9. The independent electronic steering axle according to claim 2, wherein the feedback assemblies comprise encoders, wherein the encoders are respectively arranged at the two ends of the swing axle and electrically connected to the main controller, and an input shaft of each of the encoders is provided with a feedback gear engaged with the rotary rack wheel.

10. The independent electronic steering axle according to claim 3, wherein the feedback assemblies comprise encoders, wherein the encoders are respectively arranged at the two ends of the swing axle and electrically connected to the main controller, and an input shaft of each of the encoders is provided with a feedback gear engaged with the rotary rack wheel.

11. The independent electronic steering axle according to claim 4, wherein the feedback assemblies comprise encoders, wherein the encoders are respectively arranged at the two ends of the swing axle and electrically connected to the main controller, and an input shaft of each of the encoders is provided with a feedback gear engaged with the rotary rack wheel.

12. The independent electronic steering axle according to claim 5, wherein the feedback assemblies comprise encoders, wherein the encoders are respectively arranged at the two ends of the swing axle and electrically connected to the main controller, and an input shaft of each of the encoders is provided with a feedback gear engaged with the rotary rack wheel.

13. The independent electronic steering axle according to claim 2, wherein the feedback assemblies comprise potentiometers, wherein the potentiometers are respectively arranged at the two ends of the swing axle and electrically connected to the main controller, and an input shaft of each of the potentiometers is provided with a feedback gear engaged with the rotary rack wheel.

14. The independent electronic steering axle according to claim 3, wherein the feedback assemblies comprise potentiometers, wherein the potentiometers are respectively arranged at the two ends of the swing axle and electrically connected to the main controller, and an input shaft of each of the potentiometers is provided with a feedback gear engaged with the rotary rack wheel.

15. The independent electronic steering axle according to claim 4, wherein the feedback assemblies comprise potentiometers, wherein the potentiometers are respectively arranged at the two ends of the swing axle and electrically connected to the main controller, and an input shaft of each of the potentiometers is provided with a feedback gear engaged with the rotary rack wheel.

16. The independent electronic steering axle according to claim 5, wherein the feedback assemblies comprise potentiometers, wherein the potentiometers are respectively arranged at the two ends of the swing axle and electrically connected to the main controller, and an input shaft of each of the potentiometers is provided with a feedback gear engaged with the rotary rack wheel.

17. The four-fulcrum counterbalance forklift according to claim 8, wherein in the independent electronic steering axle, the swing axle is rotatably connected to the vehicle body through a connecting shaft and a connecting base on a symmetrical axis.

18. The four-fulcrum counterbalance forklift according to claim 17, wherein in the independent electronic steering axle, the power output shaft of each of the steering motors is drivingly connected to a reducer, the steering gear engaged with the rotary rack wheel is mounted on an output shaft of the reducer, and a motor encoder electrically connected to the motor controller is built in each of the steering motors.

19. The four-fulcrum counterbalance forklift according to claim 18, wherein the rotary rack wheel and the steering gear are configured in gear structures engaged with each other.

20. The four-fulcrum counterbalance forklift according to claim 18, wherein the rotary rack wheel and the steering gear are configured in sprocket structures and drivingly connected by a chain.
